(19) United States
(12) Patent Application Publication
(10) Pub. No.: US 2008/0037576 A1
(43) Pub. Date: Feb. 14, 2008

(54) Media broadcast over an internet protocol (IP) network

(76) Inventors: Cherng-Daw Hwang, San Jose, CA (US); Steven Wang, Cupertino, CA (US); Weiping Li, Palo Alto, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/170,291

(22) Filed: Jun. 28, 2005

(51) Int. Cl. H04J 3/26

(52) U.S. Cl. 370/432

(57) ABSTRACT

A multimedia communication system in an Internet Protocol (IP) network includes broadcast capabilities. A system-wide emergency broadcast initiated by a user with the appropriate authority interrupts all teleconferences in progress. A group-wide high priority broadcast initiated by a user with the appropriate authority may interrupt some teleconferences in progress in the selected or other group(s). A group-wide normal priority broadcast allows all teleconferences to remain in progress and user may choose to join or not join the broadcast when the in-progress teleconference has ended.

### FIELD

Embodiments of the present invention relate to multimedia communication sessions and collaboration and in particular to allowing multiple users to communicate with each other in real time through delivery of high-quality video, audio, images, text, and documents through Internet Protocol (“IP”) networks.

### BACKGROUND

Broadcast television has proven to be an effective approach to providing multimedia content. This is especially true when sending content to a large audience because the same content can be sent to millions of viewers at the same time. The connection is not point-to-point so the content can be sent from a single source to multiple recipients. However, on an IP network, broadcast or multicast at the IP level have not been widely used because the IP network routers do not support broadcast or multicast at the IP level.

Although having the advantage of reaching a large audience easily, broadcast television also has limitations. For example, the broadcaster has no way of knowing whether the television is on or off or whether a viewer is presently watching. The IP network can easily provide such back-channel information from the receiver to the sender.

Currently, video and audio streaming over the IP network is not a good solution for media broadcast due to several issues. First, it uses a pull model, instead of a push model and a user's client device has to make a request to a streaming server for media content. Second, it uses unicast and multiple copies of the same media content are sent to the multiple users requesting the content. Third, it uses a large cache buffer and the delay is large.

### SUMMARY

Embodiments of present invention provide a solution for media broadcast over IP networks. The solution provides the same advantage of the television broadcast for media content to reach a large audience. It does not rely on IP multicast. It is better than television broadcast because it is able to send receiver information back to the sender by taking advantage of the interactive nature of the IP network. It uses a push model, instead of a pull model, so that an emergency broadcast can be forcefully delivered to everyone. It does not waste network bandwidth by sending multiple copies of the same content unnecessarily. It uses real-time media processing so that the delay is short.

Embodiments of the present invention relate to methods of communicating multimedia data, such as audio, video, documents, thumbnails, white board, buddy list, control data, etc., over an IP network in which end-point devices may want to make an emergency broadcast of multimedia data to other end-point devices. The emergency broadcast may be implemented using real-time routing servers and a system server.

For some embodiments, a real-time routing server may receive a notification from a system server to prepare for an emergency broadcast of multimedia data by a host end-point device. In response to the notification, the real-time routing server may terminate any teleconference in progress that the real-time routing server is associated with, invite associated end-point devices that are on-line and ready to receive the emergency broadcast to join the emergency broadcast, receive the emergency broadcast from the host end-point device, and send the multimedia data in the emergency broadcast to the end-point devices that are on-line and ready after receiving the emergency broadcast from the host end-point. The real-time routing server may release its communication resources and multicast or unicast the multimedia data in the emergency broadcast to the end-point devices that are on-line and ready.

The real-time routing server may determine whether an associated end-point device is off-line, on-line, and/or ready to receive the emergency broadcast. If the end-point device is off-line, the real-time routing server may invite the off-line end-point device to join the emergency broadcast if and when the off-line end-point device comes on-line. If the end-point device is on-line, the real-time routing server may take a “roll-call” to determine whether a human user is physically present at the on-line end-point device. If the end-point device is on-line but not ready to receive the emergency broadcast, it may delay the action to join the emergency broadcast until it is ready to receive the emergency broadcast.

For alternative embodiments, a real-time routing server may receive a notification from a system server to prepare for non-emergency broadcast of multimedia data by a host end-point device to a group of end-point devices. If the broadcast is to be a high priority broadcast, then in response to the notification to prepare for the broadcast, the real-time routing server may terminate any teleconference in progress for its associated end-point devices in the group, invite the associated end-point devices in the group that are on-line and ready to receive the broadcast to join the broadcast, receive the broadcast from the host end-point device, and send the multimedia data in the broadcast to the associated end-point devices in the group that are on-line and ready.

If the broadcast is to be a normal priority broadcast, then in response to the notification to prepare for the broadcast, allowing any teleconference in progress among its associated end-point devices in the group to continue until scheduled to end, when the teleconference ends, inviting the associated end-point devices in the group that are on-line and ready to receive the broadcast to join the broadcast, receiving the broadcast from the host end-point device, and sending the multimedia data in the broadcast to the end-point devices in the group that are on-line and ready to receive broadcast multimedia data.

A high priority group broadcast may use a second real-time routing server that has no end-point devices in the group associated with it. If there are insufficient resources on the second real-time routing server to perform the high priority broadcast, the real-time routing server may request that a teleconference in progress associated with the second real-time network routing server that is not associated with the broadcast be terminated. The real-time routing server associated with the broadcast may then utilize the communication resources of the terminated teleconference for the broadcast.

For other embodiments, a system server may receive a request for an end-point device to host an emergency broadcast of multimedia data. The system server may determine whether the user using the end-point device has authority to host an emergency broadcast. If the user does not have the authority, then the system server may deny the request. If the user has the authority, then the system server may accept the request, notify real-time routing servers in the network that an emergency broadcast of multimedia data is about to occur, and permit the end-point to conduct the emergency broadcast.

The system server may confirm that the end-point device has made the request to host the emergency broadcast. The system server also may determine whether another emergency broadcast of multimedia data is in progress. If another emergency broadcast of multimedia data is in progress, then the server may deny or delay accepting the request to host the emergency broadcast until the other emergency broadcast has ended.

For still other embodiments, the system server may receive a request from an end-point device to host a broadcast of multimedia data to a group of end-point devices in the network. The system server may determine whether the hosting user authority is emergency, high priority, or normal.

If the requesting user has emergency broadcast hosting authority, then the system server may permit the requesting user to host an emergency broadcast, a high priority level broadcast, or a normal priority level broadcast. If the requesting user has high priority hosting authority, then the system server may permit the requesting user to host a high priority level broadcast or a normal priority level broadcast. If the requesting user has normal broadcast hosting authority, then the system server may permit the requesting user to host only a normal priority level broadcast.

If permission is granted to the requesting end-point device to host a broadcast, the system server may notify real-time routing servers in the network that a broadcast of multimedia data is about to occur. The system server also may perform a roll call of users participated in the broadcast.

For some embodiments, an end-point device may send a request to host a broadcast of multimedia data. The end-point device may receive notification from the system server to prepare for a broadcast of multimedia data. The end-point device may check the notification to see if the username in the notification matches the username of the end-point device. If the username in the notification matches the username of the end-point device, then the end-point device has received permission to host the broadcast and broadcasts multimedia data in the network. If the username in the notification does not match the username of the end-point device, then the end-point device has not received permission to host the broadcast and the end-point device does not broadcast.

The host end-point device may broadcast multimedia data to all real-time routing servers having end-point devices that are on-line and ready to receive the multimedia data in the network. The host user may select a group of users to receive the multimedia data and broadcast multimedia data to real-time routing servers having end-point devices that are on-line and ready to receive the multimedia data and that are in the group. Other features and advantages of the present invention will be apparent from the accompanying drawings and from the detailed description that follows.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a communication system according to an embodiment of the present invention;

FIGS. 2A and 2B illustrate a flow chart of an approach to operating the communication system depicted in FIG. 1 according to an embodiment of the present invention;

FIGS. 3A and 3B illustrate a flow chart of an approach to operating the communication system depicted in FIG. 1 according to an alternative embodiment of the present invention; and

FIG. 4 is a diagram of database depicted in FIG. 1 according to an embodiment of the present invention.

### DETAILED DESCRIPTION

As will be described in more detail below a multimedia communication system integrates multimedia data such as audio, video, data collaboration, instant messaging, and chatting, for example into one system that allows multimedia data to be broadcast over an Internet Protocol (IP) network. There are two modes of broadcast: system-wide broadcast and group-wide broadcast. A group-wide broadcast may be a high priority broadcast or a normal priority broadcast. The system-wide broadcast may have a higher priority than any group-wide broadcast.

The system has three components: one or more multimedia application routing server(s) (MARS), several end-point devices, such as one or more personal computers (PC), set-top boxes, desk-top boxes, and/or personal digital assistants (PDA), with software and a camera and a headset (or microphone and speaker) on each end-point device for users to conduct the teleconference, and a management server, which manages registered users and IP network components.

An end-point device may make a system-wide emergency broadcast of multimedia data to all the MARS in the network or a group-wide broadcast of multimedia data to selected MARS. In this manner, multimedia data is broadcast or multicast at the application level and no IP multicast support is needed. The system also includes a “roll call” feature for each end-point device, which is used to determine whether a user is physically present at the end-point device, and can determine whether an end-point is on-line or off-line.

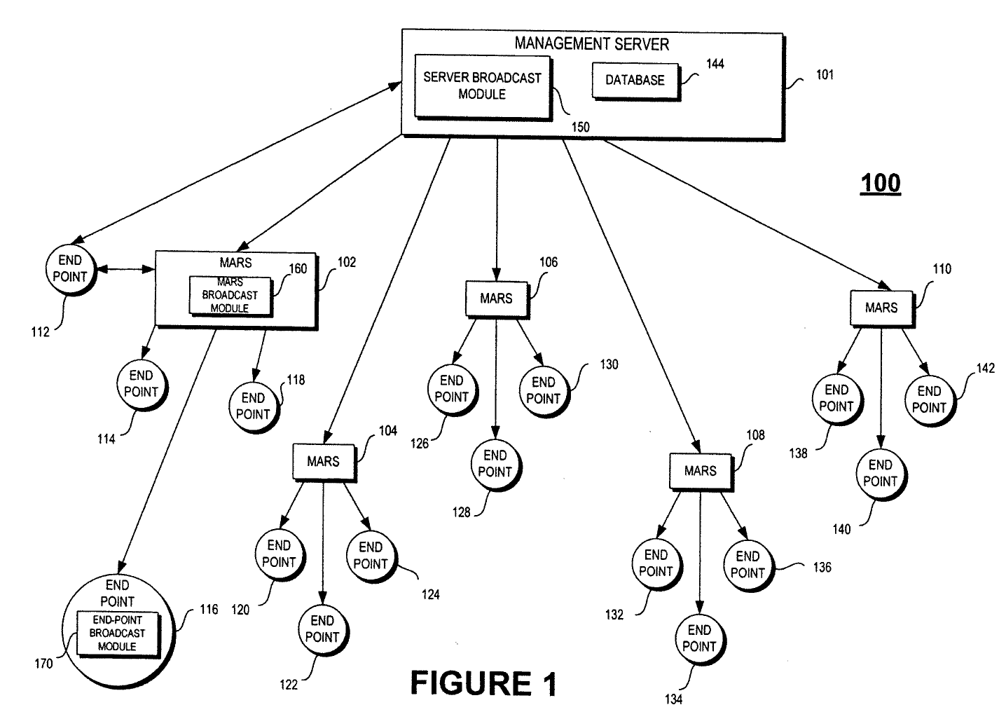

FIG. 1 is a high-level block diagram of a communication system 100 according to an embodiment of the present invention. In the illustrated embodiment, the system 100 includes a Multimedia Application Routing Server (MARS) 102, a MARS 104, a MARS 106, a MARS 108, and a MARS 110. Each illustrated MARS 102, 104, 106, or 108 is coupled to a management server 101 and several end-point devices over an Internet Protocol (IP) network, for example.

The illustrated MARS 102 is coupled to several end-point devices 112, 114, 116, and 118. The illustrated MARS 104 is coupled to several end-point devices 120, 122, and 124. The illustrated MARS 106 is coupled to several end-point devices 126, 128, and 130. The illustrated MARS 108 is coupled to several end-point devices 132, 134, and 136. The illustrated MARS 110 is coupled to several end-point devices 138, 140, and 142.

The example communication system 100 may allow users of the end-point devices to send and receive multimedia data in real time with minimal delay so that the users can communicate and collaborate with each other.

An individual MARS (102, 104, 106, or 108) may route multimedia data and process multimedia data in real time. Accordingly, a MARS may be referred to herein as a real-time routing server. A MARS may utilize any suitable technique for finding a route for the multimedia data.

The management server 101 may manage multimedia communications sessions over the network of the system 100. In the management server 101, there may be several software processes running to manage communication sessions within the management server 101's group of users. There also may be several software processes running to exchange information with other management servers 101 so that session may be conducted across groups. The software processes running in the management server 101 may include a provisioning server, a web server, and processes relating to multimedia collaboration and calendar management. For one embodiment, the management server 101 may use the Linux operating system.

An individual end-point device (112, 114, 116, 118, 120, 122, 124, 126, 128, 130, 132, 134, 136, 138, or 140) may be a personal computer (“PC”) running as a software terminal, a dedicated hardware device connection with user interface devices, and/or a combination of a PC and a hardware device. The example individual end-point device may be used for a human user to schedule and conduct a multimedia communication session. The example individual end-point device may be capable of capturing inputs from user interface devices, such as a video camera, an audio microphone, a pointing device (such as a mouse, for example), a typing device such as a keyboard, for example, and any image/text display on the monitor. The example individual end-point device also may be capable of sending outputs to user interface devices such as a PC monitor, a TV monitor, a speaker, and an earphone, for example.

The example individual end-point device also may encode and decode multimedia data according to the network bandwidth and the computing power of the particular end-point device. The example individual end-point device may send encoded multimedia data to its associated real-time routing server, receive encoded multimedia data from its associated real-time routing server, may decode the multimedia data and send the decoded multimedia data to the output devices.

The example individual end-point device also may process communication messages transmitted between the example individual end-point device and its associated real-time routing server. The messages may include scheduling a meeting, joining a meeting, inviting another user to a meeting, exiting a meeting, setting up a call, answering a call, ending a call, taking control of a meeting, arranging video positions of the meeting participants, updating buddy list status, checking the network connection with the real-time routing server, and so on.

The illustrated management server 101 includes a database 144. The database 144 may keep information for each communication session for all the end-point devices registered in the system. The information in the database 144 for each end-point device thus may include connection bandwidth, computing power, display capability, IP address, login username, and ID (email address), video display layout, list of bit streams, etc.

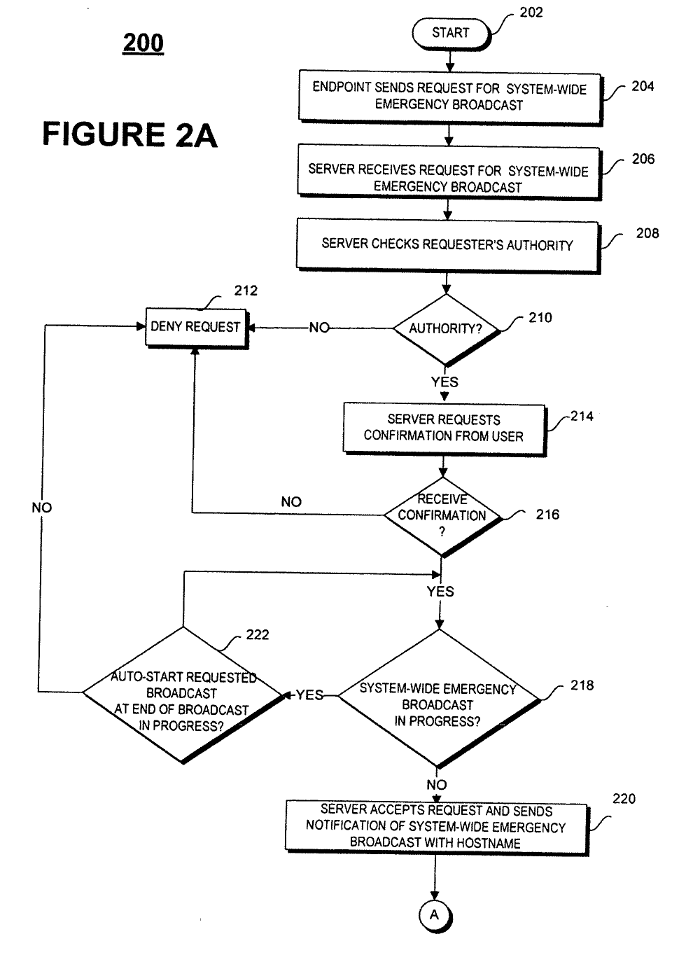

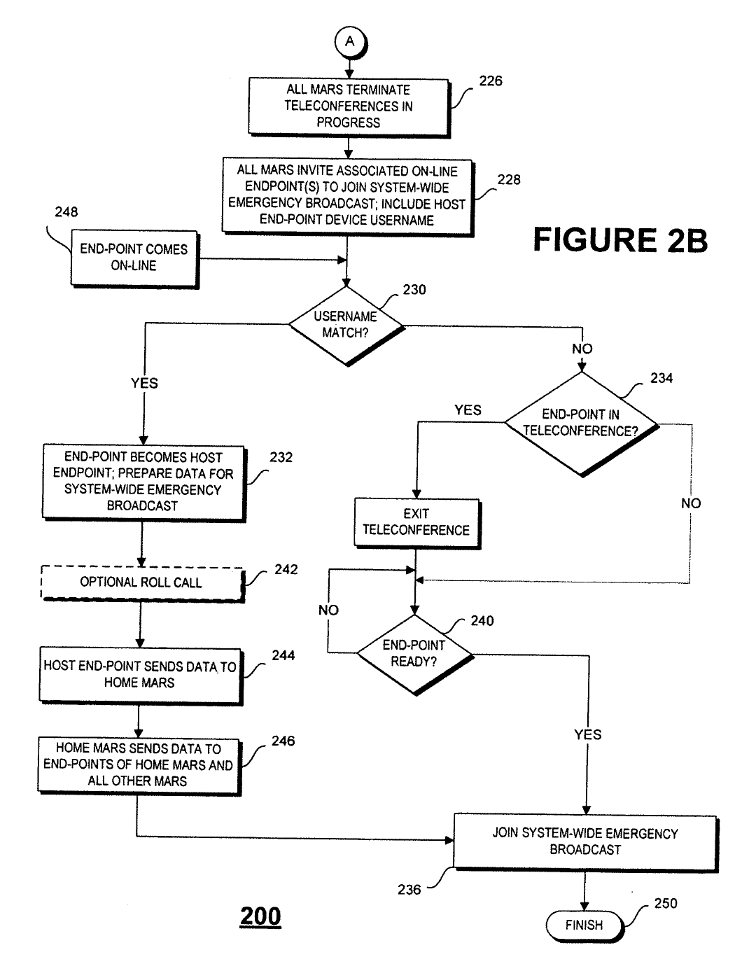

The illustrated management server 101 includes a server broadcast module 150. Operation of the broadcast module 150 is described below with reference to FIGS. 2A, 2B, 3A, 3B, and 4.

The illustrated MARS 102 includes a MARS broadcast module 160. For purposes of clarity, only the MARS 102 is shown as having the MARS broadcast module 160, however, the remaining MARS in the system 100 also may have MARS broadcast modules 160. Operation of the broadcast module 160 is described below with reference to FIGS. 2A, 2B, 3A, 3B, and 4

The illustrated end-point device 116 includes an end-point device broadcast module 170. For purposes of clarity, only the end-point device 116 is shown as having the end-point device broadcast module 170, however, the remaining end-point devices in the system 100 also may have end-point device broadcast modules 170. Operation of the broadcast module 170 is described below with reference to FIGS. 2A, 2B, 3A, 3B, and 4.

FIGS. 2A and 2B illustrate a method 200 for operating the system 100 according to an embodiment of the present invention. For purposes of illustration, assume that end-point device 112 wishes to make a system-wide emergency broadcast in the system 100.

The method 200 begins with block 202, where control may pass to block 204. In the block 204, the end-point device 112 sends a request to make a system-wide broadcast. A system-wide broadcast request may be made by clicking on a button on the end-point device 112.

For some embodiments, the broadcast module 170 in the end-point device 112 sends the request to the MARS 102, which then sends the request to the management server 101. For other embodiments, the broadcast module 170 in the end-point device 112 sends the request to the management server 101 without going through the MARS 102.

In block 206, the broadcast module 150 the management server 101 receives the request.

In block 208, the broadcast module 150 in the management server 101 determines whether the end-point 112 has the authority to make a system-wide emergency broadcast. For some embodiments, one or more users may be assigned the authority by the system administrator to make a system-wide emergency broadcast. The authority of the end-point 112 may be stored in the database 144.

If the end-point 112 does not have the authority to make a system-wide emergency broadcast, then control passes to block 212 in which the broadcast module 150 in the management server 101 denies the request.

If the end-point 112 has the authority to make a system-wide emergency broadcast, then control passes to block 214 in which the broadcast module 150 in the management server 101 requests confirmation from the user at the end-point device 112 that the user wishes to make a system-wide emergency broadcast. For some embodiments, a confirmation window may pop up on the display of the end-point device 112 for the authorized user to confirm the request to make the system-wide emergency broadcast.

If the management server 101 does not receive confirmation from the user at the end-point device 112 that he or she wants to make a system-wide emergency broadcast, then the broadcast module 150 in the management server 101 denies the request.

If the broadcast module 150 in the management server 101 receives confirmation from the user at the end-point device 112 that he or she wants to make a system-wide emergency broadcast, then in block 218 the broadcast module 150 in the management server 101 determines whether a system-wide emergency broadcast is already in progress. If a system-wide emergency broadcast is already in progress, then in block 222 the broadcast module 150 in the management server 101 requests an answer from the user at the end-point device 112 whether he or she wants to start the system-wide emergency broadcast automatically upon the in-progress system-wide emergency broadcast ending. If the answer is yes, then the method 200 performs a loop until the in-progress system-wide emergency broadcast has ended. If the answer is no, then control passes to block 212 in which the broadcast module 150 in the management server 101 denies the request.

If a system-wide emergency broadcast is not in progress, then in block 220 the broadcast module 150 in the management server 101 accepts the request from the end-point device 112 and sends notification to the broadcast module 160 in the MARS 102, 104 106, 108, and 110 that a system-wide emergency broadcast is about to begin.

In block 226, the broadcast module 160 in the MARS 102, 104 106, 108, and 110 terminate any pre-scheduled or ad hoc teleconferences that are in progress. For an on-going pre-scheduled teleconference, the termination is implemented by users “exiting” the session rather than “ending” the session. An end is a termination in which the teleconference host terminates the teleconference and the teleconference is removed from the schedule. An exit is a termination in which a user gets out of the teleconference but the teleconference remains on the schedule. Terminating the teleconference by “exit” ensures that the resource reservations for the teleconference are preserved and the users may re-join the same pre-scheduled teleconference, if any time remains, after the system-wide emergency broadcast is concluded.

In block 228, the broadcast module 160 in the MARS 102, 104 106, 108, and 110 send invitations to join the system-wide emergency broadcast to all their associated end-point devices 112-142. For some embodiments, the invitations may include the username for the end-point device 112, which is the host end-point device. Usernames may be stored in the database 144.

In block 230, the broadcast module 170 in each end-point device 112-142 determines whether its username matches the username in the invitation to join the system-wide emergency broadcast. If the username in the invitation matches the username of the end-point device, then the matching end-point device becomes the host end-point device. In keeping with the example, the username of the end-point device 112 will match the username in the invitation. Because there is a match, control passes to block 232.

In block 232, the host end-point device 112 prepares the multimedia data to be broadcast. For some embodiments, the host end-point device 112 may include the appropriate codec (not shown) and may have the capabilities to encode the multimedia data into the formats as instructed by the real-time routing server 102, such as according to one of several coding schemes, such as International Telecommunication Union (ITU) coding standards (H.261, H.263, H.264) or International Organization for Standardization (ISO) coding standards (Moving Picture Expert Group (MPEG) 1, 2, 4) or other national coding standards.

If there is not a match, control passes to block 234 in which it is determined whether an end-point device is currently in a teleconference. If an end-point device is not currently in a teleconference, then control passes to block 240. If an end-point device is currently in a teleconference, then in block 238 the end-point device exits the teleconference and control passes to block 240.

In block 240 it is determined whether the end-point device is ready to join the system-wide emergency broadcast. This may be the case when the end-point device has exited a teleconference, but there may be messages on the screen and the end-point device is still in the process of exiting. If the end-point device is not ready, the method 200 performs a loop until the end-point device is ready. If the end-point device is ready, the method 200 passes to block 236 and joins the system-wide emergency broadcast.

In block 242, an optional roll call feature may be invoked so that the host end-point device 112 is able to know whether users are physically present at the other end-point devices during the system-wide emergency broadcast. For some embodiments, the broadcast module 170 in the host end-point device 112 can send an “are you there?” message to all the other end-point devices in the system 100 one-by-one. For other embodiments, at the time of the start of the system-wide emergency broadcast, roll call may be automatically taken, such as by causing a pop-up message to appear on the display of the end-point devices. The users associated with the end-point devices may click a button on the end-point device indicating “yes I am here.”

In block 244, the broadcast module 170 in the host end-point device 112 sends the encoded multimedia data to its home MARS 102.

In block 246, the broadcast module 170 in the MARS 102 sends the encoded multimedia data to end-point devices 114, 116, and 118, if they are on-line, and to the MARS 104 106, 108, and 110. For some embodiments, if the MARS 102, 104 106, 108, and 110 form a local area network with their associated end-point devices, the MARS 102, 104 106, 108, and 110 may multicast the multimedia data in the system-wide emergency broadcast to their associated end-point devices.

In block 248, an end-point device previously off-line comes on-line.

In block 250, the method 200 finishes. For some embodiments, when a system-wide emergency broadcast is concluded, the system 100 may come back to the normal status and users may be able to start a teleconference, join a teleconference already in progress, or be invited to join a teleconference originally scheduled but preempted by the system-wide emergency broadcast.

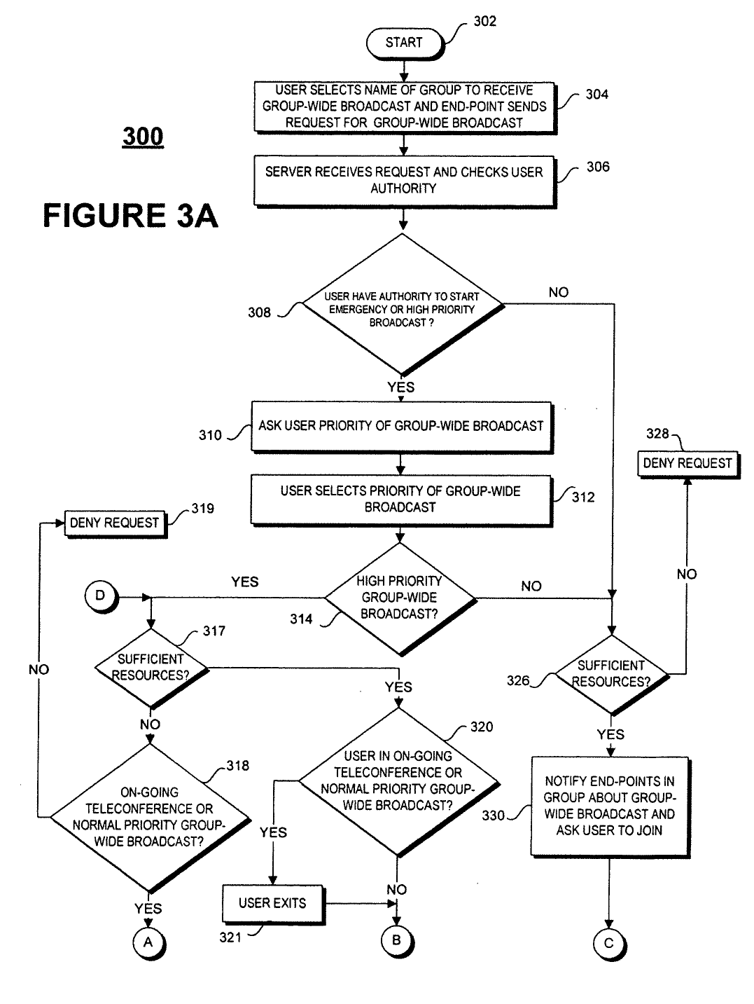

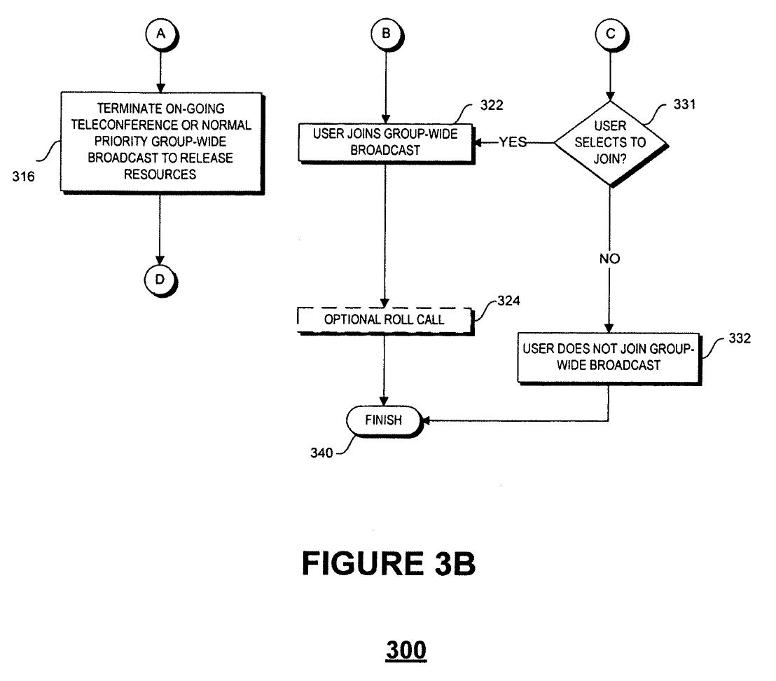

FIGS. 3A and 3B illustrate a method 300 for operating the system 100 according to an alternative embodiment of the present invention. For purposes of illustration, assume that end-point device 112 wishes to make a group-wide broadcast in the system 100.

The method 300 begins with block 302, where control passes to block 304. In block 304, the end-point device 112 sends a request to make a group-wide broadcast and selects the name of the group to receive the broadcast. For some embodiments, a user can double click a group name or select a set of groups in the buddy list to call.

Group names may be stored in the database 144. Users associated with an individual MARS may, by default, form a group. The system administrator may exclude a MARS from receiving group-cast, may define a group with multiple MARS units included, and/or may assign a name to each group.

A user may include a group name into a buddy list. A graphic icon on the end-point device display may be used to differentiate a group from a user in the buddy list.

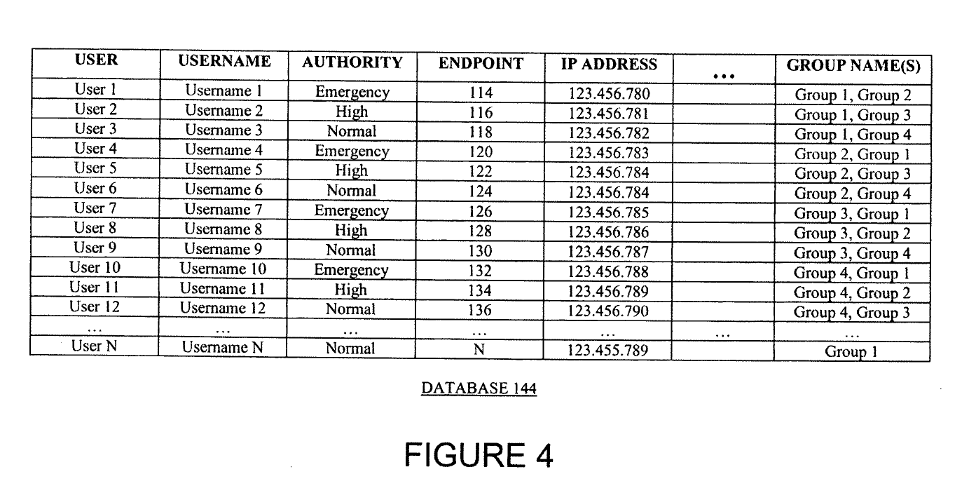

FIG. 4 illustrates the database 144 according to an embodiment of the present invention. Suppose for purposes of explanation that the user at the end-point 112 selects Group 1, which according to the database 144 illustrated in FIG. 4 includes end-point devices 114, 116, 118, 120, 126, and 132.

In block 306, the broadcast module 150 in the management server 101 may receive the request for a group-wide broadcast and checks the authority of the user.

In a block 308, the broadcast module 150 in the management server 101 may determine whether the user has high priority or emergency broadcast authority. If the user has either high priority or emergency broadcast authority, then in block 310 the broadcast module 150 in the management server 101 may ask the user for the priority of the group-wide broadcast. If a user has normal broadcast authority, the broadcast module 150 in the management server 101 may not ask the user for the priority of the group-wide broadcast because the user can only start a normal priority group-wide broadcast.

In block 312, the user may select the priority of the group-wide broadcast. The system administrator may assign user authority for system-wide emergency broadcast, high priority group-wide broadcast, and normal priority group-wide broadcast. If a user has a certain privilege to initiate a group-wide broadcast, the user may be able to start a group-wide broadcast to all groups except the ones excluded by the system administrator.

In block 314, the broadcast module 150 in the management server 101 may determine whether the user selected high priority group-wide broadcast.

If the user selected high priority group-wide broadcast, control passes to block 317 to check whether there are sufficient resources for the high priority group-wide broadcast.

If there will be sufficient resources to conduct the group-wide broadcast, then in block 320 the broadcast module 160 may determine whether a user is in an on-going teleconference or normal priority group-wide broadcast. If there will not be sufficient resources to conduct the group-wide broadcast, control passes to block 318 to check whether there is any on-going teleconference or normal priority group-wide broadcast.

In block 318, the broadcast module 150 in the management server 101 may determine whether there is any other on-going teleconference or normal priority group-wide broadcast. If there is, then in block 316, the broadcast module 150 in the management server 101 may terminate any other on-going teleconferences or normal priority group-wide broadcasts to release resources used. If not, then in block 319 the broadcast module 150 in the management server 101 may deny the request. That is, if there is insufficient resources and there are no other on-going teleconferences or normal priority group-wide broadcasts to release resources, then the broadcast module 150 in the management server 101 may deny the request to make a high priority group-wide broadcast.

After terminating an on-going teleconference or normal priority group-wide broadcast in block 316, control passes back to block 317 to check whether there are sufficient resources. The loop of 317, 318, and 316 continues until one of the following two cases happens. The first case is that there are sufficient resources after terminating some on-going teleconferences or normal priority group-wide broadcasts. In this case, control passes to block 320. The second case is that there are not sufficient resources and there are no more on-going teleconferences or normal priority group-wide broadcasts to be terminated. In this case, control passes to block 319 and the request is denied.

If in block 317, the broadcast module 160 in the home MARS 102 determines that there are sufficient resources, then in block 320 the broadcast module 160 in the home MARS may determine whether a user is in an on-going teleconference or normal priority group-wide broadcast. If the user is in an on-going teleconference or normal priority group-wide broadcast, then in block 321 the user exits the on-going teleconference or normal priority group-wide broadcast. After exiting the on-going teleconference or normal priority group-wide broadcast, in block 322 the user joins the high priority group-wide broadcast. If the user is not in an on-going teleconference or normal priority group-wide broadcast, then in block 322 the user joins the high priority group-wide broadcast.

If in block 314 the user did not select high priority group-wide broadcast, then the user selects a normal priority broadcast. Control passes to block 326, the broadcast module 160 in the home MARS 102 may determine whether there are sufficient resources available to conduct the normal priority group-wide broadcast. If not, then in block 328 the broadcast module 160 in the home MARS may deny the request. If yes, then in block 330 the broadcast module 160 in the home MARS may notify the end-point devices in Group 1 about the normal priority group-wide broadcast and ask the users in Group 1 to join the normal priority group-wide broadcast.

In block 331, the broadcast module 160 in the home MARS may determine whether a user selects to join the normal priority group-wide broadcast. For some embodiments, the broadcast module 170 in each involved end-point device causes display of a message for the user to click “Accept” or “Decline” to join or not join the normal priority group-wide broadcast. If the broadcast module 150 in the management server 101 determines that the user has selected to not join, then in block 332 the user does not join the normal priority group-wide broadcast. For some embodiments, a list of normal priority group-wide broadcasts may be maintained in a user interface window and the user may choose to join any one of them after initially declining them by click an entry of the list in the user interface window.

If the broadcast module 150 in the management server 101 determines that the user has selected to join the normal priority group-wide broadcast, then in block 322, the user joins the normal priority group-wide broadcast.

In block 324, the broadcast module 150 in the management server 101 may invoke an optional roll call feature so that the host end-point device 112 is able to know whether users are physically present at the other end-point devices during the group-wide broadcast.

In block 340, the method 300 finishes. For some embodiments, all accepting end-point devices receive multimedia data in the normal priority group-wide broadcast from the end-point 112. Teleconferences remain in progress until they are scheduled to end.

Embodiments of the present invention may be implemented using hardware, software, or a combination thereof. In implementations using software, the software may be stored on a machine-accessible medium.

A machine-accessible medium includes any mechanism that may be adapted to store and/or transmit information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “for one embodiment” or “in an embodiment” in various places throughout this specification does not necessarily mean that the phrases all refer to the same embodiment. The particular features, structures, or characteristics may be combined in any suitable manner in one or more embodiments.

In practice, the methods described herein may constitute one or more programs made up of machine-executable instructions. Describing the method with reference to the flow charts enables one skilled in the art to develop such programs, including such instructions to carry out the operations (acts) represented by the logical blocks on suitably configured computer or other types of processing machines (the processor of the machine executing the instructions from machine-readable media). The machine-executable instructions may be written in a computer programming language or may be embodied in firmware logic. If written in a programming language conforming to a recognized standard, such instructions can be executed on a variety of hardware platforms and for interface to a variety of operating systems.

In addition, embodiments of the invention are not limited to any particular programming language. A variety of programming languages may be used to implement embodiments of the invention.

Furthermore, it is common in the art to speak of software, in one form or another (i.e., program, procedure, process, application, module, logic, etc.), as taking an action or causing a result. Such expressions are merely a shorthand way of saying that execution of the software by a machine caused the processor of the machine to perform an action or produce a result. More or fewer processes may be incorporated into the methods illustrated without departing from the scope of the invention and that no particular order is implied by the arrangement of blocks shown and described herein.

Embodiments of the invention have been described. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for broadcasting multimedia data over a network, comprising:
receiving a notification to prepare for an emergency broadcast of multimedia data by a host end-point device;
in response to the notification, terminating any teleconference in progress;
inviting associated end-point devices that are on-line and ready to receive the emergency broadcast to join the emergency broadcast;
receiving the emergency broadcast from the host end-point device; and
sending the multimedia data in the broadcast to the associated end-point devices that are on-line and ready.

2. The method of claim 1, further comprising releasing communication resources in preparation for the emergency broadcast.

3. The method of claim 1, further comprising determining that an end-point device is on-line.

4. The method of claim 3, further comprising determining that an on-line end-point device is ready to receive the emergency broadcast.

5. The method of claim 3, further comprising determining that at least one on-line end-point device is not ready to receive the emergency broadcast and delaying inviting the on-line end-point device to join the emergency broadcast until the on-line end-point device is ready to receive the emergency broadcast.

6. The method of claim 1, further comprising:
determining that an end-point device is off-line; and
inviting the off-line end-point device to join the emergency broadcast when the end-point device comes on-line.

7. The method of claim 1, wherein each end-point device is associated with a user and further comprising determining whether the user is present at the on-line end-point device.

8. The method of claim 1, further comprising multicasting the emergency broadcast multimedia data to the associated end-point devices.

9. A method for broadcasting multimedia data over a network, comprising:
receiving a notification to prepare for a broadcast of multimedia data from a host end-point device to a group of end-point devices in the network;
if the broadcast is to be a high priority broadcast, then in response to the notification to prepare for the broadcast, terminating any teleconference in progress for its associated end-point devices in the group, inviting users associated with end-point devices that are on-line and ready to receive the high priority broadcast to join the high priority broadcast, receiving the broadcast from the host end-point device, and sending the multimedia data in the broadcast to the associated end-point devices in the group that are on-line and ready; and
if the broadcast is to be a normal priority broadcast, then in response to the notification to prepare for the broadcast, allowing any teleconference in progress among the associated end-point devices in the group to continue until scheduled to end, when the teleconference ends, inviting the associated end-point devices in the group that are on-line and ready to receive the broadcast to join the broadcast, receiving the broadcast from the host end-point device, and sending the multimedia data in the broadcast to the associated end-point devices in the group that are on-line and ready to receive broadcast multimedia data.

10. The method of claim 9, further comprising:
determining that there are insufficient resources to perform the high priority broadcast;
determining that there are on-going teleconferences and/or normal priority group-wide broadcasts;
terminating the on-going teleconferences and/or normal priority group-wide broadcasts;
accepting the request for the high priority group-wide broadcast; and
utilizing the communication resources of the terminated teleconferences and/or normal priority group-wide broadcasts for the high priority broadcast.

11. The method of claim 9, further comprising:
determining that there are insufficient resources to perform the high priority broadcast;
determining that there are no on-going teleconferences or normal priority group-wide broadcasts; and
denying the request for the high priority group-wide broadcast.

12. The method of claim 9, further comprising:
determining that there are sufficient resources to perform the high priority broadcast;
determining that a user in the group is in an on-going teleconference or normal priority group-wide broadcast;
forcing the user to exit the on-going teleconference or normal priority group-wide broadcast; and
inviting the user to join the high priority group-wide broadcast.

13. The method of claim 9, further comprising:
determining that there are sufficient resources to perform the high priority broadcast;
determining that a user in the group is in not an on-going teleconference or normal priority group-wide broadcast; and
inviting the user to join the high priority group-wide broadcast.

14. The method of claim 9, further comprising:
determining that there are insufficient resources to perform the normal priority broadcast; and
denying the request for the normal priority group-wide broadcast.

15. The method of claim 9, further comprising:
determining that there are sufficient resources to perform the normal priority broadcast;
notifying the end-point devices in the group that a normal priority group-wide broadcast is about to begin; and
sending an invitation to users associated with the end-point devices in the group to join the normal priority group-wide broadcast.

16. The method of claim 15, further comprising receiving an acceptance to the invitation to join the normal priority group-wide broadcast.

17. The method of claim 15, further comprising:
receiving a decline of the invitation to join the normal priority group-wide broadcast; and
maintaining a list of normal priority group-wide broadcasts for the user to join later.

18. The method of claim 9, further comprising determining whether the user is present at the end-point device in the group.

19. The method of claim 9, further comprising multicasting the multimedia data in the broadcast to the end-point devices in the group.

20. The method of claim 9, further comprising:
determining that an end-point device in the group is off-line; and
inviting the off-line end-point device to join the broadcast if the end-point device in the group comes on-line.

21. A method for broadcasting multimedia data over a network, comprising:
receiving a request for an end-point device to host an emergency broadcast of multimedia data;
determining whether the end-point device has authority to host an emergency broadcast;
if the end-point device does not have authority to host an emergency broadcast, then denying the request;
if the end-point device has authority to host an emergency broadcast, then:
accepting the request;
notifying real-time routing servers in the network that an emergency broadcast of multimedia data is about to occur; and
permitting the end-point to conduct the emergency broadcast.

22. The method of claim 21, further comprising confirming the request to host the emergency broadcast of multimedia data.

23. The method of claim 22, further comprising:
determining whether another emergency broadcast of multimedia data is in progress; and
if so, then denying or delaying accepting the request to host the emergency broadcast of multimedia data until the other emergency broadcast has ended.

24. The method of claim 22, further comprising whether the host wants to perform a roll call of users associated with end-point devices.

25. The method of claim 24, further comprising storing results of the roll call.

26. A method for broadcasting multimedia data over a network, comprising:
receiving a request from an end-point device to host a broadcast of multimedia data to a group of end-point devices;
determining hosting authority of the requesting end-point device;
determining a priority level for the broadcast of multimedia data;
if the requesting end-point device has emergency broadcast hosting authority and/or high priority hosting authority, then permitting the requesting end-point device to host an emergency broadcast, a high priority level broadcast, or a normal priority level broadcast;
if the requesting end-point device has high priority hosting authority, then permitting the requesting end-point device to host a high priority level broadcast or a normal priority level broadcast;
if the requesting end-point device has normal broadcast hosting authority, then permitting the requesting end-point device to host only a normal priority level broadcast.

27. The method of claim 26, further comprising notifying real-time routing servers in the network that a broadcast of multimedia data is about to occur.

28. The method of claim 26, further comprising querying a real-time routing server associated with the host end-point device whether the real-time routing server wants to perform a roll call of users associated with end-point devices in the group.

29. The method of claim 26, further comprising querying the host end-point device whether the host end-point device wants to perform a system-wide emergency broadcast, a high priority group-wide broadcast, or a normal priority group-wide broadcast.

30. The method of claim 26, further comprising storing results of the roll call.

31. A method for broadcasting multimedia data over a network, comprising:
sending a request to host a broadcast of multimedia data;
receiving a notification to prepare for broadcast of multimedia data;
checking notification for username match;
if there is a username match, then broadcasting multimedia data in the network;
if there is no username match, then receiving broadcast multimedia data.

32. The method of claim 31, further comprising broadcasting multimedia data to all real-time routing servers having end-point devices that are on-line and ready to receive the multimedia data.

33. The method of claim 31, further comprising selecting a group of end-point devices to receive the multimedia data.

34. The method of claim 33, further comprising broadcasting multimedia data to real-time routing servers having end-points that are on-line and ready to receive the multimedia data and are in the group.
